(19) United States
(12) Patent Application Publication
(10) Pub. No.: US 2007/0037649 A1
(43) Pub. Date: Feb. 15, 2007

(54) BELT DRIVE

(75) Inventor: Rainer Pflug, Heilsbronn (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 11/463,935

(22) Filed: Aug. 11, 2006

Related U.S. Application Data
(60) Provisional application No. 60/707,291, filed on Aug. 11, 2005.

(51) Int. Cl. F16H 55/30; F16H 55/36; F16H 7/00

(52) U.S. Cl. 474/141; 474/148

(57) ABSTRACT

A belt drive (1) with belt means (4), with at least one driving traction pulley (2), and one driven traction pulley (3) is provided by the invention, with at least one of the traction pulleys (2, 3) having a non-circular shape. It has been found that an especially advantageous effect can be made on the vibration behavior of the belt means (4) and accordingly the belt drive (1) by the selection of a definite angle of belt contact (α) and a constant contact length of the belt means (4) on at least one non-circular traction pulley (2, 3). Consequently, the angle of belt contact (α) and the contact length are set according to the invention to the one or more non-circular traction pulleys (2, 3) such that these are nearly constant in each rotational position of the traction pulleys (2, 3).

### CROSS-REFERENCE TO RELATED APPLICATIONS

This application is a non-provisional of U.S. patent application Ser. No. 60/707,291, filed Aug. 11, 2005, which is incorporated herein by reference as if fully set forth.

### FIELD OF THE INVENTION

The invention relates to a belt drive with a belt means, at least one driving traction pulley, and a driven traction pulley, with at least one of the traction pulleys having a non-circular shape.

### BACKGROUND OF THE INVENTION

Belt or chain drives, in which a crankshaft drives the camshafts of an internal combustion engine, wherein these camshafts open and close the inlet and outlet valves of the engine, are used, in particular, in motor vehicles.

Belt or chain drives are subjected to mechanical vibration stimulation, which on its side places a load on the belt or chain drive, due to variations in torque or changes in angular velocity and engine speed during operation. In resonance ranges, such vibrations also lead disadvantageously to audible noise. This noise is associated with increased frictional forces, which negatively affects the service life of the belt drive, as well as its efficiency. Furthermore, susceptibility to error increases and the driving comfort, e.g., in a motor vehicle, decreases.

In order to effectively combat this problem, different measures have become known. Thus, it is already known to form a driving and/or driven traction pulley with a non-circular shape and/or to mount it eccentrically. Through this measure, the belt drive is misaligned by means of an additional unevenness, whereby critical resonance ranges are shifted into a non-disruptive range (DE 195 20 508 A1, DE 202 20 367 U1).

In addition, from DE 195 20 508 A1, it is known to combine the non-circular and/or eccentrically mounted wheels or traction pulleys with a belt, especially a toothed belt, which is embodied, on its side, with changing longitudinal elasticity. Furthermore, in this document it is proposed to form a known spring-loaded tension wheel arranged in the slack belt section of the belt drive with a non-circular shape and/or to mount it eccentrically, which should be able to realize a shift in resonance.

Furthermore, in unpublished German Patent Application 10 2004 025 936.4, a belt drive for an internal combustion engine with belt means embodied as a belt or chain is proposed, which is guided over driving or driven wheels of the crankshaft and at least one camshaft of the internal combustion engine and/or secondary assemblies to be driven. Here it is essentially proposed to form at least one of the driving or driven wheels or a deflection wheel with a non-circular shape or to mount it eccentrically and/or to provide at least two tension rolls, with one of these tension rolls being provided with a damping device or both being coupled to each other and a damping device.

In DE 202 20 367 U1, it is also proposed to combat a fluctuating torque or the vibration stimulation by an internal combustion engine in a belt drive, such that the belt drive has a traction pulley with a non-circular profile, with the angular position of the preceding and following sections of the non-circular profile relative to the angular position of the second traction pulley, as well as the extent of the eccentricity of the non-circular profile being formed such that the non-circular profile applies an opposite, fluctuating, and correcting torque to the second traction pulley, which on its side reduces or essentially cancels the fluctuating torque. Consequently, this approach tries to provide special influence on the vibration damping by means of the angular position of the non-circular traction pulley relative to the second circular traction pulley, as well as through the extent of the eccentricity.

In addition, from U.S. Pat. No. 4,865,577, non-circular chain drives with non-circular chain wheels are known. To minimize vibrations in the chain slack, it is essentially proposed to arrange the wheels relative to each other so that the corresponding run-in and run-out points of the chain do not lie on a common tangent to the two wheels.

With these known measures, resonance shifting with a definite, advantageous effect on the operation and the efficiency of the belt drive, as well as the driving comfort of a vehicle with such a belt drive, can be achieved. In spite of this, these measures are still accompanied by other certain complications, especially when these are combined, for example, with known, so-called camshaft dampers and/or belts with high-quality cords.

Consequently, the technical world is still working on finding other advantageous solutions, in order to combat the named problem of the vibration stimulation effectively and economically.

### SUMMARY OF THE INVENTION

Thus, the invention is based on the objective of creating a solution, which distinguishes itself especially advantageously from the state of the art for reducing vibrations on a belt drive and which can be realized especially simply and economically.

The invention is based on the knowledge that an especially advantageous effect can be made on the vibration behavior of the belt means and consequently the belt drive through the selection of a defined angle of belt contact αof the belt means on at least one non-circular traction pulley.

Consequently, the invention relates to a belt drive with belt means, at least one driving traction pulley, and one driven traction pulley, with at least one of the traction pulleys having a non-circular shape. To solve the stated problem, it is also provided that the angle of belt contact αand the contact length of the belt means are adjusted to the one or more non-circular traction pulleys, such that these are nearly constant in each rotational position of the traction pulley.

The subordinate claims describe preferred improvements or configurations of the invention, which are described briefly below.

Accordingly, it has been found that an optimal angle of belt contact αcan be determined particularly conveniently from the condition
α=360°/OZ

where OZ stands for the ordinal number of the non-circular pulley that is used or for a second, third, fourth, or n-th order traction pulley.

According to a first advantageous configuration of the invention, an angle of belt contact of α=180° is to be set for a second order traction pulley, namely a traction pulley with an elliptical form.

A second configuration provides a third order (triangular form) traction pulley, with an angle of belt contact of α=120° or a whole-number multiple of this angle, but preferably an angle of belt contact of α=120°, being set.

According to a third embodiment, a fourth order (rectangular form) traction pulley is provided, with an angle of belt contact of α=90° or a whole-number multiple of this angle, but preferably an angle of belt contact of α=180°, being set.

For a fifth order (pentagonal form) traction pulley, an angle of belt contact of α=72° or a whole-number multiple of this angle, but preferably an angle of belt contact of α=144°, is set.

In contrast, finally for a sixth order (hexagonal form) traction pulley, an angle of belt contact of α=60° or a whole-number multiple of this angle, but preferably an angle of belt contact of α=120°, is set.

In particular, for a belt drive, which connects the crankshaft to the camshaft of a three-cylinder internal combustion engine, it has proven to be advantageous when the traction pulley on the camshaft is embodied as a third order (triangular form) traction pulley with an angle of belt contact of α=120° or a whole-number multiple of this angle, but preferably with an angle of belt contact of α=120°, and the traction pulley of the crankshaft is embodied with a circular shape.

In contrast, for a four-cylinder internal combustion engine, it has proven to be advantageous to embody the traction pulley of the camshaft as a fourth order (rectangular form) traction pulley with an angle of belt contact of α=90° or a whole-number multiple of this angle, but preferably with an angle of belt contact of α=180°, or to embody the traction pulley of the crankshaft as a second order (elliptical) traction pulley with an angle of belt contact of α=180°.

For a five-cylinder internal combustion engine, the traction pulley of the camshaft should be embodied as a fifth order (pentagonal form) traction pulley with an angle of belt contact of α=72° or a whole-number multiple of this angle, but preferably with an angle of belt contact of α=144°, and the traction pulley of the crankshaft should be formed with a circular shape for realizing an effect according to the invention.

In contrast, for a six-cylinder internal combustion engine, the traction pulley of the camshaft is to be embodied as a sixth order (hexagonal form) traction pulley with an angle of belt contact of α=60° or a whole-number multiple of this angle, but preferably with an angle of belt contact of α=120°, or the traction pulley of the crankshaft is to be embodied as a third order (triangular form) traction pulley with an angle of belt contact of α=120° or a whole-number multiple of this angle, but preferably with an angle of belt contact of α=120°.

Finally, as the invention also provides, the angle of belt contact αor the contact length of the belt means can be set in an especially preferred way by means of a certain ratio of dimensions of the associated traction pulleys and/or through the selection of the spacing of these pulleys and/or via aids, such as deflection pulleys, deflection rolls, or tension rolls, and/or guide rails.

The proposed solution for the belt drive has the significant advantage with reference to conventional belt drives that this drive can be realized simply and economically and also is extremely effective in terms of reducing vibrations. In addition, the proposed measures for the belt drive can also be combined advantageously with known measures already discussed above, in order to improve the desired effect even more.

### BRIEF DESCRIPTION OF THE DRAWINGS

The invention is explained in more detail below with reference to the enclosed drawing using a few embodiments. Shown are

FIG. 1 a belt drive in the simplest configuration with a driving traction pulley and a driven traction pulley,

FIG. 2 the one or more non-circular traction pulley of a conventional belt drive in a first rotational position (state of the art),

FIG. 3 the traction pulley from FIG. 2 in a second rotational position (state of the art),

FIG. 4 a non-circular traction pulley of a belt drive according to the invention in a first rotational position, and

FIG. 5 the traction pulley from FIG. 4 in a second rotational position.

### DETAILED DESCRIPTION OF THE PREFERRED EMBODIMENTS

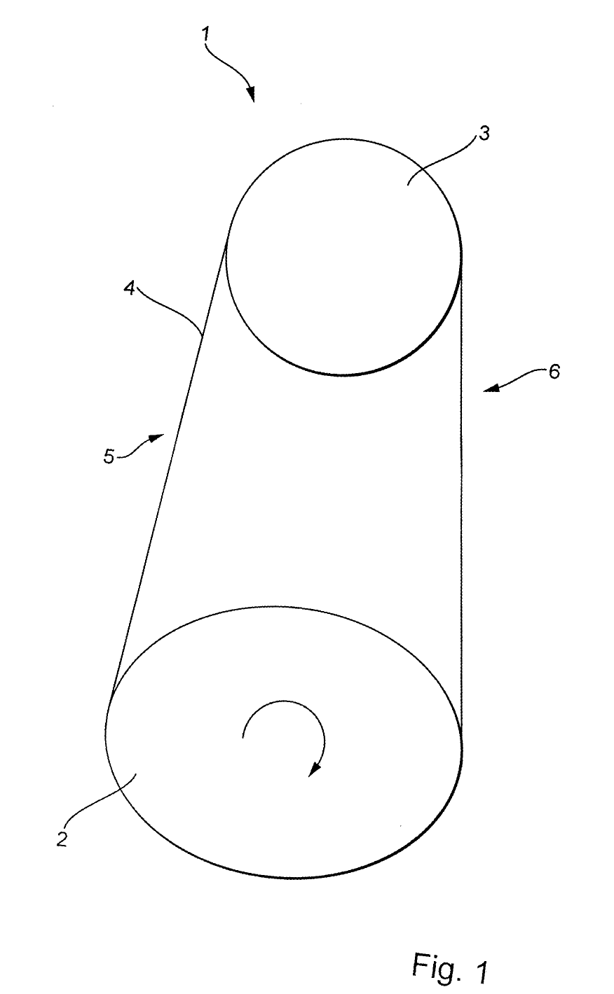

The belt drive 1 shown very schematically in FIG. 1 has in the simplest conceivable configuration a driving traction pulley 2 and a driven traction pulley 3, around which are wrapped endless belt means 4 for torque transmission. Both a chain and also a belt, preferably a toothed belt, are possible as the belt means 4.

If this belt drive 1 represents, for example, the belt drive of an internal combustion engine not shown in more detail, the traction pulley 2 is effectively connected to the driving crankshaft of the internal combustion engine and the traction pulley 3 is effectively connected to the driven camshaft of this engine.

Furthermore, as to be taken from FIG. 1, the traction pulley 2 is embodied using known means and methods as a second order non-circular traction pulley 2, which corresponds to an elliptical form. Just this measure alone can have an effect to a certain extent on a desired vibration reduction, as already explained above, in that mechanical vibration stimulation of the belt drive 1 originally caused by the internal combustion engine or its fluctuations in torque or changes in angular velocity and engine speed is advantageously superimposed and reduced by means of an additionally generated misalignment of the belt drive, resulting from the said non-circular configuration of at least one traction pulley 2. However, in practice it has been shown that the resulting vibration reduction is not yet adequate and must be improved.

In studies it has been found that by means of the selection of the angle of belt contact a and the contact length of a belt means 4 on at least one non-circular traction pulley 2 and/or 3, an especially advantageous effect can be made on the vibration behavior of the belt means 4 and consequently the belt drive 1 as a system unit.

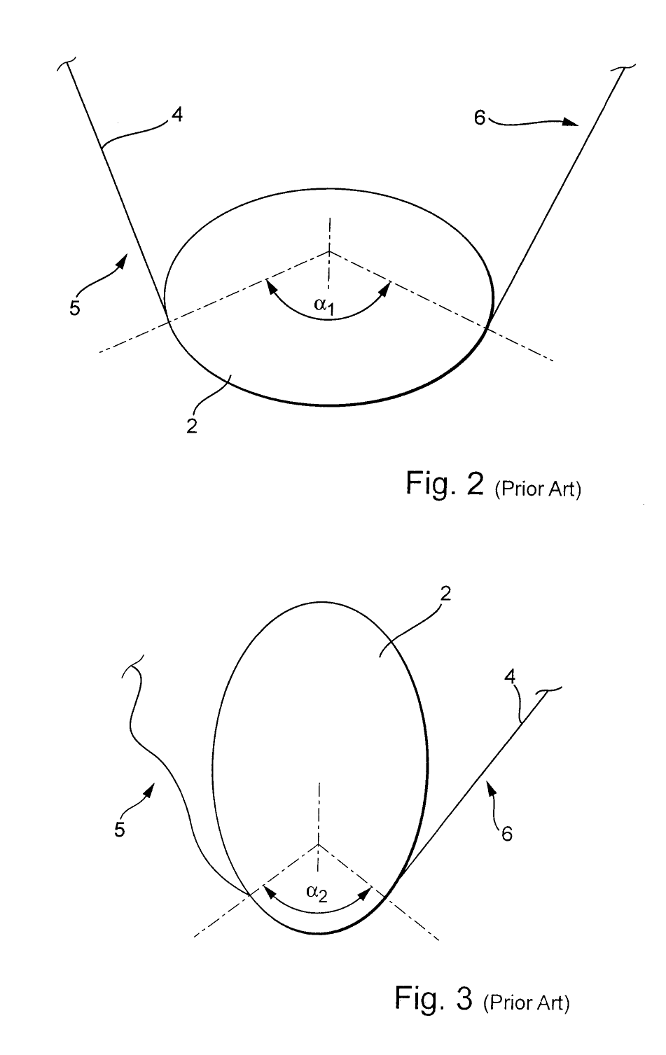

FIGS. 2 and 3 each show a second order (elliptical) non-circular traction pulley 2 of a conventional belt drive 1 effectively connected, for example, to the driving crankshaft of the internal combustion engine, with a belt means 4 wrapped around the traction pulley 2 in two representative rotational positions, in the present example, with the traction pulley 2 being shown rotating in the clockwise direction.

As it is not difficult to take from the drawing, in the two shown rotational states of the traction pulley 2, angle of belt contact α₁ and α₂ are set such that different belt arc lengths or contact lengths of the belt means are created, which, on their side and in turn, generate fluctuating lengths of the belt means 4, especially in the slack belt section 5 of the belt drive 1, in comparison to which, the tension in the tensioned belt section 6 of this drive remains essentially constant. These fluctuating length changes in the slack belt section 5 are the cause for disadvantages vibrations.

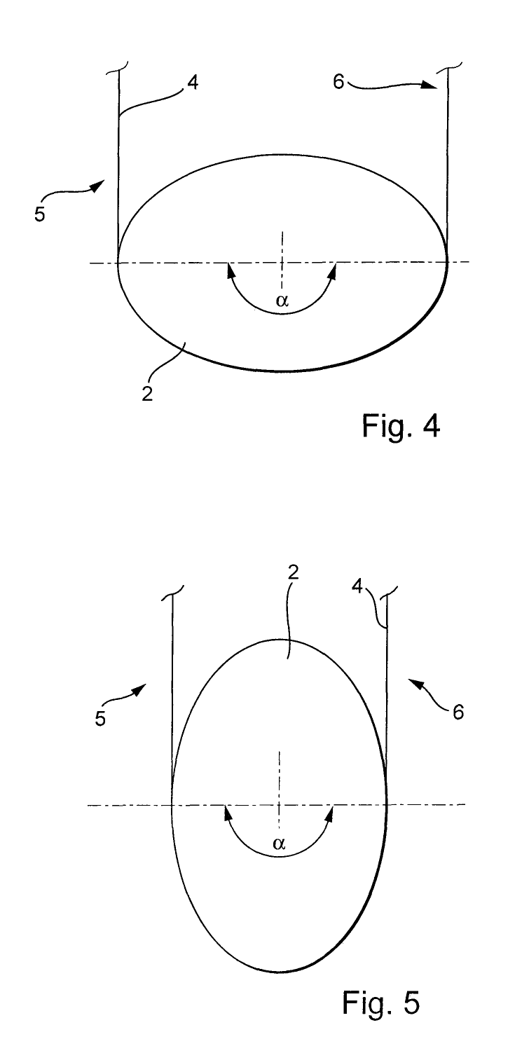

To combat these circumstances, according to the invention the angle of belt contact α and the contact length of the belt means are adjusted to the one or more non-circular traction pulleys 2, such that these are nearly constant in each rotational position of the traction pulley 2. Thus, FIGS. 4 and 5 show the traction pulley 2 with the belt means 4 wrapping around this pulley in the arrangement according to the invention in two representative rotational positions.

Accordingly, for the second order (elliptical) traction pulley 2 a definite angle of belt contact of α=180° is set, which, on its side, leads to the fact that in each rotational position of the traction pulley 2, first there is a constant angle of belt contact a with constant contact length of the belt means, and second an essentially constantly taut belt means 4 is realized both in the slack belt section 5 and also in the tensioned belt section 6. Disadvantageous vibrations in the belt means 4 are thus advantageously prevented.

However, the invention is not limited to the previously shown second order traction pulley 2 described in detail, but instead encompasses all non-circular traction pulleys 2 and 3, accordingly also third, fourth, fifth, sixth, or n-th order pulleys, whose embodiments are not shown here in more detail.

In the scope of the named studies, for example, for a known third order (triangular form) traction pulley 2, an angle of belt contact of α=120° has proven to be especially advantageous. In contrast, a whole-number multiple of this angle of belt contact a can also be set, accordingly, for example, α=240°. However, an angle of belt contact of α=120° is given preference, because a set angle of belt contact of α=240° would demonstrate reduced effectiveness in this actual case.

For a belt drive 1 with a fourth order (rectangular form) traction pulley 2, an angle of belt contact of α=90° or a whole-number multiple of this angle, preferably an angle of belt contact of α=180°, has proven effective.

If a fifth order (pentagonal form) traction pulley 2 is used, an angle of belt contact of α=72° or a whole-number multiple of this angle, preferably an angle of belt contact of α=144°, is favored.

For a sixth order (hexagonal form) traction pulley 2, an angle of belt contact of α=60° or a whole-number multiple of this angle, but preferably an angle of belt contact of α=120°, is presented.

In an especially convenient way, the optimal angle of belt contact αfor the selected traction pulley 2, accordingly also up to an n-th order pulley, can be determined from the condition
α=360°/ OZ

where the term OZ stands for the ordinal number of the non-circular traction pulley 2 that is used or for a second, third, fourth, or n-th order traction pulley 2.

The setting of the appropriate angle of belt contact αand the mentioned contact length of the belt means is performed preferably by means of a certain ratio of dimensions of the associated traction pulleys 2, 3 and/or through the selection of the spacing of these pulleys from each other, and/or by means of aids, which are not shown in more detail, but which are known, such as, for example, deflection pulleys, deflection rolls, or guide rails.

Furthermore, in addition to the traction pulley 2, it is also possible to embody the traction pulley 3 according to the conditions named above, which presents itself especially for a belt drive 1, which connects the crankshaft to the camshaft of an internal combustion engine (not shown in more detail).

The possibility of determining a supposedly optimal angle of belt contact a for each selected traction pulley 2, 3 according to the condition above computationally, however, has shown in tests related to a belt drive 1 for an internal combustion engine that traction pulleys 2 and 3 of arbitrary order cannot be combined with each other indiscriminately, in order to achieve the desired effect of the greatest possible vibration reduction.

Accordingly, it was found, e.g., that for a belt drive 1, which connects the crankshaft to the camshaft of a three-cylinder internal combustion engine, the best results are achieved when the traction pulley of the camshaft 3 is embodied as a third order (triangular) traction pulley 3 with an angle of belt contact of α=120° or a whole-number multiple, but preferably with an angle of belt contact of α=120°, and the traction pulley of the crankshaft 2 is embodied with a circular shape (not shown in more detail).

Other especially advantageous variants of the belt drive 1, in addition to the variants already described above, are shown below in table form for reasons of simplicity as a function of the number of cylinders of an internal combustion engine, namely for a four, five, and six cylinder internal combustion engine. The values in parentheses represent the computationally determined angle of belt contact α, which, however, is not favored in the present example.

| | Construction of the belt drive 1 | |
|---|---|---|
| | [alternative] | |
| Number of cylinders of an | Traction pulley 3 | Traction pulley 2 |
| internal combustion engine | Camshaft | Crankshaft |
| 3 | 3rd order | Circular form |
| | (triangular form) | |
| | α = 120° | |
| 4 | 4th order | 2nd order |
| | (square form) | (elliptical) |
| | α = 180° (90°) | α = 180° |
| 5 | 5th order | Circular form |
| | (pentagonal form) | |
| | α = 144° (72°) | |
| 6 | 6th order | 3rd order |
| | (hexagonal form) | (triangular form) |
| | α = 120° (60°) | α = 120° |

List of Reference Symbols
1 belt drive
2 Traction pulley or traction pulley of the crankshaft
3 Traction pulley or traction pulley of the camshaft
4 belt means
5 Slack belt section
6 Tensioned belt section α, α₁, α₂ Angle of belt contact

1. Belt drive, comprising belt means, at least one driving traction pulley, and one driven traction pulley, with at least one of the traction pulleys having a non-circular shape, an angle of belt contact (α) and a contact length of the belt means are set to the one or more non-circular traction pulleys, such that the angle of contact and the contact length are nearly constant in each rotational position of the traction pulleys.

2. Belt drive according to claim 1, wherein the angle of belt contact (α) can be determined from a condition
α=360°/OZ
where OZ stands for an ordinal number of the non-circular traction pulley that is used or for a second, third, fourth, or n-th order traction pulley.

3. Belt drive according to claim 2, wherein the angle of belt contact of α=180° is set for a second order (elliptical) traction pulley.

4. Belt drive according to claim 2, wherein for a third order (triangular form) traction pulley, the angle of belt contact of α=120° or a whole-number multiple of this angle.

5. Belt drive according to claim 2, wherein for a fourth order (rectangular form) traction pulley, the angle of belt contact of α=90° or a whole-number multiple of this angle.

6. Belt drive according to claim 2, wherein for a fifth order (pentagonal form) traction pulley, the angle of belt contact of α=72° or a whole-number multiple of this angle.

7. Belt drive according to claim 2, wherein for a sixth order (hexagonal form) traction pulley, the angle of belt contact of α=60° or a whole-number multiple of this angle.

8. Belt drive according to claim 1, wherein the belt drive connects the crankshaft to the camshaft of a three-cylinder internal combustion engine, and the traction pulley of the camshaft is embodied as a third order (triangular form) traction pulley with the angle of belt contact of α=120° or a whole-number multiple of this angle, and the traction pulley of the crankshaft is embodied with a circular shape.

9. Belt drive according to claim 1, wherein the belt drive connects the crankshaft to the camshaft of a four-cylinder internal combustion engine, and the traction pulley of the camshaft is embodied as a fourth order (rectangular form) traction pulley with the angle of belt contact of α=90° or a whole-number multiple of this angle, or the traction pulley of the crankshaft is embodied as a second order (elliptical) traction pulley with the angle of belt contact being set at α=180°.

10. Belt drive according to claim 1, wherein the belt drive connects the crankshaft to the camshaft of a five-cylinder internal combustion engine, and the traction pulley of the camshaft is embodied as a fifth order (pentagonal form) traction pulley with the angle of belt contact of α=72° or a whole-number multiple of this angle, and the traction pulley of the crankshaft is embodied with a circular shape.

11. Belt drive according to claim 1, wherein the belt drive connects the crankshaft to the camshaft of a six-cylinder internal combustion engine, and the traction pulley of the camshaft is embodied as a sixth order (hexagonal form) traction pulley with the angle of belt contact of α=60° or a whole-number multiple of this angle, or the traction pulley of the crankshaft is embodied as a third order (triangular form) traction pulley with the angle of belt contact of α=120° or a whole-number multiple of this angle.

12. Belt drive according to claim 1, wherein the angle of belt contact (α) can be set by a definite ratio of dimensions of the traction pulleys and/or through a selection of a spacing of the pulleys relative to each other and/or by deflection pulleys, deflection rolls, or guide rails.

13. Belt drive according to claim 5, wherein for the fourth order (rectangular form) traction pulley, the angle is set at α=180°.

14. Belt drive according to claim 6, wherein for the fifth order (pentagonal) traction pulley, the angle of belt contact is set at α=144°.

15. Belt drive according to claim 7, wherein for the sixth order (hexagonal) traction pulley, the angle of belt contact is set at α=120°.
